(19) United States
(12) Patent Application Publication
(10) Pub. No.: US 2026/0044739 A1
(43) Pub. Date: Feb. 12, 2026

(54) ADAPTIVE PRIVACY-PROTECTION DISTRIBUTED LEARNING METHOD AND DEVICE BASED ON ATTENUATED NOISE PERTURBATION

(71) Applicant: SHANDONG COMPUTER SCIENCE CENTER(NATIONAL SUPERCOMPUTER CENTER IN JINAN), Jinan (CN)

(72) Inventors: Xiaoming WU, Jinan (CN); Ming YANG, Jinan (CN); Xin WANG, Jinan (CN); Zhenya CHEN, Jinan (CN); Chao MU, Jinan (CN); Yunpeng HE, Jinan (CN)

(73) Assignee: SHANDONG COMPUTER SCIENCE CENTER(NATIONAL SUPERCOMPUTER CENTER IN JINAN), Jinan (CN)

(21) Appl. No.: 19/286,166

(22) Filed: Jul. 30, 2025

Related U.S. Application Data
(63) Continuation of application No. PCT/CN2024/133085, filed on Nov. 20, 2024.

(30) Foreign Application Priority Data
Aug. 8, 2024 (CN) 202411080709.7

(51) Int. Cl. G06N 3/084; G06F 21/62

(52) U.S. Cl. CPC G06N 3/084; G06F 21/6245

(57) ABSTRACT

This disclosure belongs to the technical field of distributed machine learning, and specifically relates to an adaptive privacy-protection distributed learning method and device based on attenuated noise perturbation. The method includes: acquiring a local gradient of a node according to a sample gradient after node clipping, wherein a clipping threshold of the node decreases with the increase of iteration rounds; injecting Gaussian noise into the local gradient, wherein the intensity of the Gaussian noise is stepwise attenuated with the increase of iteration rounds; aggregating the local gradient of the node after injection of the Gaussian noise in each iteration round, and using the aggregated gradient to update local model parameters, and broadcasting the updated local model parameters to adjacent nodes for parameter updating; and then aggregating the updated model parameters of the adjacent nodes for the next iteration.

### CROSS-REFERENCE TO RELATED APPLICATIONS

The application claims priority to Chinese patent application No. 202411080709.7, filed on Aug. 8, 2024, the entire contents of which are incorporated herein by reference.

### TECHNICAL FIELD

This disclosure belongs to the technical field of distributed machine learning, and more specifically, relates to an adaptive privacy-protection distributed learning method and device based on attenuated noise perturbation.

### BACKGROUND

With the rapid development and widespread application of artificial intelligence technology, machine learning has become a powerful tool for solving various complex problems, and a large amount of personal data is used to train and optimize machine learning models. However, as the amount of data and the complexity of models continue to increase, people need more powerful computing resources for model training. Distributed machine learning allows model training to be performed simultaneously on multiple computing nodes, so it is a method that can meet the needs of large-scale data processing and complex model training.

However, since personal data often contains sensitive information, such as identity information and medical records, the use of traditional distributed model training methods may face the risk of privacy leakage. For users, personal privacy faces increasing risks as data is shared and analyzed.

In practice, computing nodes involved in distributed machine learning typically maintain the isolation of local data thereof and only cooperate by sharing information such as model parameters or gradients. However, this information sharing poses a potential risk of data privacy leakage, as malicious parties can use this information to infer the sensitivity of the original data. Although this approach helps protect user privacy to a certain extent, attackers may still be able to infer the original data using shared model parameters or gradients, thus posing potential privacy leakage risks. Therefore, how to strike a balance between data sharing and privacy protection becomes an important research topic.

Chinese patent literature CN116911382A discloses an asynchronous aggregation and privacy protection method in resource-limited federated edge learning. The method improves the delay compensation mechanism to perform delay compensation on model parameters within a model staleness threshold range. An attenuation coefficient adopts a bell-shaped curve function. The greater the staleness, the faster the attenuation. For clients that exceed the staleness threshold, they are forced to synchronize with the current global parameters and enter the next round of local training.

Chinese patent literature CN115983598A discloses a microgrid privacy protection and energy scheduling method based on distributed deep reinforcement learning. First, an action network is used to interact with the local environment to obtain a corresponding action strategy, generate corresponding noise and independent power generation unit power, and then determine whether constraints are met based on environmental parameters and a selected action, and calculate a reward value. Then an action neural network and a value neural network extract historical data for learning. Finally, based on a learned model, a value network gives feedback to the action selected by the action network, guiding the action network to pursue higher reward values.

The above solutions can achieve privacy protection of parameters during model training.

Differential Privacy (DP) is a data privacy protection method that introduces controlled random perturbations into data to ensure that personal data does not leak sensitive information during a data analysis process. The core idea of this method is to add noise so that the specific content of the original data cannot be accurately inferred from analysis results, thereby achieving effective protection of user privacy. DP provides a solution to balance between privacy protection and data analysis, allowing AI systems to learn and extract valuable information from personal data while ensuring security of personal privacy. Among the perturbation-based privacy protection methods, differential privacy is considered to have the highest security level.

In the field of machine learning, differential privacy is usually achieved by perturbing a gradient. A common approach is to introduce perturbations by adding Gaussian noise proportional to the sensitivity of data. Therefore, the intensity of the perturbation directly affects the accuracy of data analysis. Higher perturbation intensity can provide better privacy protection, but will reduce the accuracy of data analysis, and vice versa. The level of privacy protection is closely related to the perturbation intensity. However, due to differences in characteristics and attributes of different data samples, two data samples may have greater sensitivity, resulting in excessive noise and seriously affecting the effect of model training. Therefore, how to strike a balance between privacy protection and accuracy has become an urgent problem that needs to be solved.

To solve this problem, differential privacy in the field of machine learning usually uses gradient clipping technology to limit the sensitivity of the gradient, that is, to adjust the gradient according to a pre-set clipping boundary. By gradient clipping, the introduction of noise can be controlled to balance the effects of privacy protection and model training. However, when setting the clipping boundary, balance needs to be made between a noise variance and the clipping deviation. A larger clipping boundary will introduce a larger noise variance, while a smaller boundary may cause a deviation in the gradient direction. Since errors caused by noise and gradient deviation are unavoidable, a suitable balance needs to be found when setting the clipping threshold so that differential privacy can provide sufficient privacy protection without significantly reducing the utility of the model.

This balance is an important issue in differential privacy applications in machine learning. Privacy protection, data utility, and model convergence need to be considered comprehensively, but in practical applications, it is difficult to determine the appropriate clipping threshold, and an effective method to solve this problem has not yet been found. However, most existing studies focus on symmetric undirected networks and only consider adding noise with constant variance in model updates, ignoring the possibility of time-varying adjustment of variance to mitigate noise errors.

Based on this, this disclosure designs an adaptive privacy-protection distributed learning method based on attenuated noise perturbation to solve the above problems.

### SUMMARY

This disclosure aims to overcome at least one defect of the above-mentioned existing technology and provide an adaptive privacy-protection distributed learning method based on attenuated noise perturbation, which effectively protects data privacy by adding noise, while reducing noise errors to ensure data accuracy.

This disclosure further discloses a device loaded with an adaptive privacy-protection distributed learning method based on attenuated noise perturbation.

The detailed technical solution of this disclosure is as follows:

An adaptive privacy-protection distributed learning method based on attenuated noise perturbation is applied to a distributed-type distributed learning system, the distributed learning system including a defined node and adjacent nodes thereof, and each node having a local dataset used for image classification and recognition tasks; where the method includes:
S1: acquiring a sample gradient of the defined node in a current iteration round based on the local dataset, using a clipping threshold of the current iteration round to clip the sample gradient, and using the clipped sample gradient to calculate an initial local gradient, where the clipping threshold is stepwise attenuated based on set time intervals during an iteration process;
S2: injecting Gaussian noise into the initial local gradient of the defined node to obtain an intermediate local gradient, where the intensity of the injected Gaussian noise is adjusted by noise intensity coefficients, and the intensity of the injected Gaussian noise is stepwise attenuated based on the set time intervals during the iteration process;
S3: using an adaptive historical gradient aggregation method to aggregate the intermediate local gradient of the defined node in the current iteration round and target local gradients in historical iteration rounds to obtain a target local gradient of the defined node in the current iteration round;
S4: calculating a learning rate in the current iteration round based on the noise intensity coefficients, using the target local gradient obtained through aggregation to update local model parameters of the defined node, and then passing the updated local model parameters to the adjacent nodes for model parameter updating; and
S5: receiving, by the defined node, updated model parameters of the adjacent nodes thereof and performing aggregation to obtain the local model parameters of the next iteration round.

Preferably, in S1, the sample gradient of the defined node i in the t-th iteration round is

$$∇ {f}_{i} ( {z}_{i}^{t} , {b}_{i}^{t} ) ,$$

where

$${z}_{i}^{t}$$

represents a debiasing parameter of the defined node i in the t-th iteration round, and

$${b}_{i}^{t}$$

represents a sample sampled from the local dataset Dᵢ of the defined node i in the t-th iteration round;
using a clipping threshold of the current iteration round to clip the sample gradient specifically includes: when

$$∇ {f}_{i} ( {z}_{i}^{t} , {b}_{i}^{t} ) > {Δ}_{i}^{⌊ t / {τ}_{1} ⌋} : \qquad ( 1 )$$

$$∇ {f}_{i}^{′} ( {z}_{i}^{t} , {b}_{i}^{t} ) = \frac{∇ {f}_{i} ( {z}_{i}^{t} , {b}_{i}^{t} )}{‖ ∇ {f}_{i} ( {z}_{i}^{t} , {b}_{i}^{t} ) ‖} {Δ}_{i}^{⌊ t / {τ}_{1} ⌋} ;$$

in formula (1):

$$∇ {f}_{i}^{′} ( {z}_{i}^{t} , {b}_{i}^{t} )$$

(represents the sample gradient after clipping;

$${Δ}_{i}^{⌊ t / {τ}_{1} ⌋}$$

represents the clipping threshold of the t-th iteration round; and τ₁ represents a first time interval;
where the clipping threshold is stepwise attenuated based on the set first time interval τ₁ during the iteration process, that is:

$${Δ}_{i}^{⌊ t / {τ}_{1} ⌋ + 1} = ψ {Δ}_{i}^{⌊ t / {τ}_{1} ⌋} ; \qquad ( 2 )$$

in formula (2):

$${Δ}_{i}^{⌊ t / {τ}_{1} ⌋ + 1}$$

represents the clipping threshold within the next first time interval τ₁; ψ represents an attenuation coefficient.

Preferably, in the S1, using the clipped sample gradient to calculate an initial local gradient is represented by:

$${g}_{i}^{t} = \frac{1}{B} {\sum }_{b = 1}^{B} ∇ {f}_{i}^{′} ( {z}_{i}^{t} , {b}_{i}^{t} ) ; \qquad ( 3 )$$

in formula (3):

$${g}_{i}^{t}$$

represents the initial local gradient of the defined node i in the t-th iteration round; B represents the total number of samples in the local dataset Dᵢ of the defined node i; and b represents the b-th sample in the local dataset Dᵢ.

Preferably, in the S2, injecting Gaussian noise into the initial local gradient of the defined node to obtain an intermediate local gradient is represented by:

$${\overline{g}}_{i}^{t} = {g}_{i}^{t} + {α}_{2 i}^{t} {Δ}_{i}^{⌊ t / {τ}_{1} ⌋} \cdot 𝒩 ( 0 , {σ}_{i}^{2} {I}_{d} ) ; \qquad ( 4 )$$

and
in formula (4):

$${\overline{g}}_{i}^{t}$$

represents the intermediate local gradient of the defined node i in the t-th iteration round;

$${α}_{2 i}^{t} = {α}_{i}^{⌊ ( T - t ) / {τ}_{2} ⌋} ,$$

represents a second noise intensity coefficient of the defined node i in the t-th iteration round, T represents the total number of iterations, τ₂ represents a second time interval, and the second noise intensity

$${α}_{2 i}^{t}$$

coefficient decreases stepwise based on the set second time interval τ₂ during the iteration process; and

$$𝒩 ( 0 , {σ}_{i}^{2} {I}_{d} )$$

represents Gaussian noise with an expected value of 0 and a variance of

$${σ}_{i}^{2} {I}_{d} .$$

Preferably, the S3 specifically includes:
determining whether the second noise intensity coefficient

$${α}_{2 i}^{t}$$

in the current iteration round is equal to the second noise intensity coefficient

$${α}_{2 i}^{t - 1}$$

in the previous iteration round; if

$${α}_{2 i}^{t} = {α}_{2 i}^{t - 1} ,$$

then:

$${\tilde{g}}_{i}^{t} = ( 1 - θ ) {\overline{g}}_{i}^{t} = θ {\tilde{g}}_{i}^{t - 1} ; \qquad ( 6 )$$

and
in formula (6):

$${\tilde{g}}_{i}^{t}$$

represents the target local gradient of the defined node i in the t-th iteration round; θ is a hyperparameter, with a value of [0, 1);

$${\tilde{g}}_{i}^{t - 1}$$

represents the target local gradient of the defined node i in the t−1-th iteration round.

Preferably, in the S4, calculating a learning rate in the current iteration round based on the noise intensity coefficients is represented by:

$$\{ \begin{matrix}{η}^{t} & = η / {β}_{i}^{t} \\ {β}_{i}^{t} & = \{ \begin{matrix}{α}_{1 i}^{t} {α}_{2 i}^{t} , & t \leq T / 2 \\ {α}_{1 i}^{t} {α}_{1 i}^{t} , & t > T / 2\end{matrix}\end{matrix} ; \qquad ( 9 )$$

in formula (9): η^{t} represents the learning rate in the t-th iteration round; η represents an initial learning rate;

$${β}_{i}^{t}$$

represents a learning rate coefficient of the defined node i in the t-th iteration round;

$${α}_{1 i}^{t} = {α}_{i}^{⌊ t / {τ}_{2} ⌋} ,$$

represents the first noise intensity coefficient of the defined node i in the t-th iteration round, and the first noise intensity coefficient

$${α}_{1 i}^{t}$$

increases stepwise based on the set second time interval τ₂ during the iteration process;
using the target local gradient obtained through aggregation to update local model parameters of the defined node is represented by:

$${x}_{i}^{t + 1 / 2} = {x}_{i}^{t} - {η}^{t} {\tilde{g}}_{i}^{t} ; \qquad ( 10 )$$

and
in formula (10):

$${x}_{i}^{t + 1 / 2}$$

represents the intermediate model parameters of the defined node i, obtained through updating;

$${x}_{i}^{t}$$

represents the local model parameters of the defined node i before updating.

Preferably, in the S5, receiving, by the defined node, updated model parameters of the adjacent nodes thereof and performing aggregation to obtain the local model parameters of the next iteration round specifically includes:

$$\{ \begin{matrix}{x}_{i}^{t + 1} & = {\sum }_{j = 1}^{n} {P}_{i , j}^{t} {x}_{j}^{t + 1 / 2} \\ {w}_{i}^{t + 1} & = {\sum }_{j = 1}^{n} {P}_{i , j}^{t} {w}_{j}^{t} \\ {z}_{i}^{t + 1} & = {x}_{i}^{t + 1} / {w}_{i}^{t + 1}\end{matrix} ; \qquad ( 11 )$$

in formula (11):

$${x}_{i}^{t + 1}$$

represents the local model parameters of the defined node i in the t+1-th iteration round; n represents the number of nodes;

$${P}_{i , j}^{t}$$

represents a weight from the adjacent node j to the defined node i in the t-th iteration round;

$${x}_{j}^{t + 1 / 2}$$

represents the intermediate model parameters of the adjacent nodes j, obtained through updating;

$${w}_{i}^{t + 1}$$

represents a scalar push weight of the defined node i in the t+1-th iteration round;

$${w}_{j}^{t}$$

represents the scalar push weight of the adjacent node j, obtained through updating; and

$${z}_{i}^{t + 1}$$

represents the debiasing parameter of the defined node i in the t+1-th iteration round.

In another aspect of this disclosure, a device for implementing an adaptive privacy-protection distributed learning method based on attenuated noise perturbation is provided, which includes:
a gradient acquisition module configured to acquire a sample gradient of the defined node in a current iteration round based on the local dataset, use a clipping threshold of the current iteration round to clip the sample gradient, and use the clipped sample gradient to calculate an initial local gradient, where the clipping threshold is stepwise attenuated based on set time intervals during an iteration process;
a gradient noise adding module configured to inject Gaussian noise into the initial local gradient of the defined node to obtain an intermediate local gradient, where the intensity of the injected Gaussian noise is adjusted by noise intensity coefficients, and the intensity of the injected Gaussian noise is stepwise attenuated based on the set time intervals during the iteration process;
a gradient aggregation module configured to use an adaptive historical gradient aggregation method to aggregate the intermediate local gradient of the defined node in the current iteration round and target local gradients in historical iteration rounds to obtain a target local gradient of the defined node in the current iteration round;
a parameter update module configured to calculate a learning rate in the current iteration round based on the noise intensity coefficients, use the target local gradient obtained through aggregation to update local model parameters of the defined node, and then pass the updated local model parameters to the adjacent nodes for model parameter updating; and
a parameter aggregation module configured to aggregate updated model parameters of the adjacent nodes to obtain the local model parameters of the next iteration round.

In another aspect of this disclosure, electronic equipment is further provided, which includes:
at least one processor; and a memory storing instructions, when executed by the at least one processor, the instructions enable the at least one processor to perform the adaptive privacy-protection distributed learning method based on attenuated noise perturbation as described above.

In another aspect of this disclosure, a machine-readable storage medium is further provided, the machine-readable storage medium storing executable instructions, where when executed, the instructions enable a machine to perform the adaptive privacy-protection distributed learning method based on attenuated noise perturbation as described above.

Compared with the existing technology, this disclosure has the following beneficial effects:
(1) The adaptive privacy-protection distributed learning method based on attenuated noise perturbation provided by this disclosure adopts the noise variance and clipping threshold with time variation. In the iterative process, the intensity of the injected noise is reduced stepwise to reduce the negative impact on the gradient direction. The method of adaptive aggregation of historical gradients (AA) is used to further reduce the noise error and improve the overall performance. At the same time, the noise variance and learning rate are adjusted to provide personalized privacy protection level for each node.
(2) The method of this disclosure combines the Push-Sum technology and is applicable to general time-varying communication topologies.
(3) The method of this disclosure provides for the first time convergence analysis of noise error and gradient staleness bias under a directed (asymmetric), sparse and time-varying general communication topology.

### BRIEF DESCRIPTION OF DRAWINGS

FIG. 1 is a flowchart of an adaptive privacy-protection distributed learning method based on attenuated noise perturbation according to this disclosure.

FIG. 2 (a) is a diagram showing the relationship between a value of parameter θ and a convergence effect when σᵢ=5.

FIG. 2 (b) is a diagram showing the relationship between a value of parameter θ and a convergence effect when σ₁=10.

FIG. 2 (c) is a diagram showing the relationship between a value of parameter θ and a convergence effect when σ₁=15.

FIG. 3 (a) is a diagram showing the relationship between a value of a second time interval τ₂ and a convergence effect when σᵢ=5.

FIG. 3 (b) is a diagram showing the relationship between a value of a second time interval τ₂ and a convergence effect when σ₁=10.

FIG. 3 (c) is a diagram showing the relationship between a value of a second time interval τ₂ and a convergence effect when σ₁=15.

FIG. 4 is a comparative experimental diagram of the method of this disclosure and other methods.

### DETAILED DESCRIPTION OF THE EMBODIMENTS

This disclosure is further described below in conjunction with the accompanying drawings and embodiments.

It should be noted that the following detailed descriptions are exemplary and are intended to provide further illustration of this disclosure. Unless defined otherwise, all technical and scientific terms used herein have the same meaning as commonly understood by those of ordinary skill in the art to which this disclosure belongs.

It should be noted that the terms used herein are for describing specific embodiments only and are not intended to limit the exemplary embodiments according to this disclosure. As used herein, unless the context clearly indicates otherwise, the singular forms are intended to include the plural forms. Furthermore, it should be understood that when the terms “include” and/or “comprise” are used in this specification, they indicate the presence of features, steps, operations, devices, components and/or combinations thereof.

In the absence of conflict, the embodiments in this disclosure and the features in the embodiments may be combined with each other.

In view of the defects of the existing technology, this disclosure provides an adaptive privacy-protection distributed learning method based on attenuated noise perturbation, named DP-ASGP, which can be used to solve non-convex optimization problems. This method can achieve a personalized privacy protection level for each node and is applicable to general time-varying network topologies.

The adaptive privacy-protection distributed learning method and device based on attenuated noise perturbation of this disclosure are further described below in conjunction with specific embodiments.

### Embodiment 1

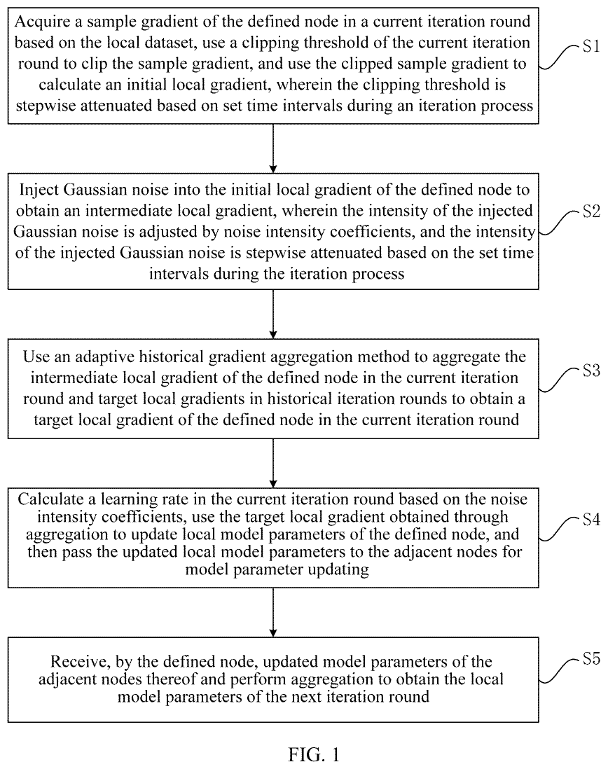

Referring to FIG. 1, in one embodiment, an adaptive privacy-protection distributed learning method based on attenuated noise perturbation, applied to a distributed learning system, is provided. The distributed learning system includes a defined node and adjacent nodes thereof, and each node has a local dataset used for image classification and recognition tasks.

For the distributed-type distributed learning system, there is no separate server. Each node contained thereby acts as both a server and a working node, and the nodes can interact directly with each other. In this embodiment, a time-varying directed communication network may be described, and nodes may pass information based on this communication network.

It is assumed that there is a time-varying directed graph G(t). For the time-varying directed graph G(t)=(V, ε(t)), V represents a node set and ε(t) represents a directed edge set at the t-th iteration round. A non-negative mixing matrix Q(t)∈R_{n×n} is used to represent the time-varying directed graph G(t) at the t-th iteration round. i represents the defined node, and j represents the adjacent node of the defined node i, and (i,j)∈ε(t).

$${P}_{i , j}^{t} ( t )$$

represents a weight from the adjacent node j to the defined node i in the t-th iteration round. If

$${P}_{i , j}^{t} ( t ) > 0 ,$$

it means that the adjacent node j sends a message to the defined node i in the t-th iteration round. If

$${P}_{i , j}^{t} ( t ) = 0 ,$$

it means that the adjacent node j does not send a message to the defined node i in the t-th iteration round. For a non-negative mixing matrix Q(t), the matrix is set to be column random (i.e., the sum of each column is 1), that is

$${I}_{d}^{⊤} * Q ( t ) = {I}_{d} ,$$

where I_{d} represents a unit vector. R_{n×n} represents the set of all real matrices of order n×n, and n represents the number of nodes.

In one embodiment, a random gradient pushing method based on a time-varying directed topological structure is proposed. This approach allows each node to choose its mixing weights arbitrarily, without being influenced by other nodes. During the learning process, each node needs to maintain three variables: model parameter x, scalar push weight w, and debiasing parameter z.

Based on the above communication environment, the method of this embodiment includes:
S1: acquiring a sample gradient of the defined node in a current iteration round based on the local dataset, using a clipping threshold of the current iteration round to clip the sample gradient, and using the clipped sample gradient to calculate an initial local gradient, where the clipping threshold is stepwise attenuated based on set time intervals during an iteration process.

In the distributed learning system, each node has a local dataset Dᵢ used for image classification and recognition tasks. In this embodiment, the local dataset Dᵢ contains B samples, which can be obtained from the CIFAR-10 dataset.

The CIFAR-10 dataset is a standard dataset widely used for image classification tasks. It was created by Alex Krizhevsky, Vinod Nair, and Geoffrey Hinton at the University of Toronto, Canada. The dataset contains 10 different categories of color images, each category contains 6000 images, a total of 60000 32×32 pixel color images. Image categories include airplanes, cars, birds, cats, deer, dogs, frogs, horses, boats, and trucks.

The CIFAR-10 dataset is divided into a training set and a test set, where the training set contains 50,000 images and the test set contains 10,000 images. The pixel values of each image range from 0 to 255, representing the color intensity in the RGB color space. Each image has a corresponding label, which is an integer between 0 and 9, indicating the category it belongs to.

In specific application scenarios, the CIFAR-10 dataset can be used for distributed learning, such as collaborative learning among multiple research institutions or companies to jointly train an image classification model to recognize and classify images of common objects. Each participant performs local training using its own subset of data and shares model updating via distributed learning without exchanging actual data. In this process, noise can be introduced through differential privacy technology to protect the data privacy of each participant and ensure that personal or company-level data will not be leaked, thereby improving the overall performance and security of the model. This approach could be used to develop smart surveillance systems, object recognition systems in autonomous driving, and real-time image classification capabilities in augmented reality devices.

For the defined node i, the node can use the local dataset Dᵢ to obtain the sample gradient thereof in each iteration round. It is set that the total number of iterations is T. In the t-th iteration round (t∈T), the sample gradient of the defined node i in the t-th iteration round is

$$∇ {f}_{i} ( {z}_{i}^{t} , {b}_{i}^{t} ) ,$$

where

$${z}_{i}^{t}$$

represents the debiasing parameter of the defined node i in the t-th iteration round, and

$${b}_{i}^{t}$$

represents the sample of the defined node i sampled from the local dataset Dᵢ in the t-th iteration round.

Considering that the intensity of noise is related to the sensitivity of sample data, the second norm of the gradient is usually used to measure the sensitivity of sample data in the local dataset when adding Gaussian noise. It is set G represents the maximum value of the gradient second norm and A represents the clipping threshold after application the clipping technique. When clipping is not applied, the variance of the added noise is (G/Δ)² times that with clipping, and the noise added to the gradient will increase significantly, so clipping is usually required to control it. Clipping techniques are essential in differential privacy.

In this embodiment, gradient clipping is performed only when the acquired sample gradient is greater than the clipping threshold in the current iteration round. That is, for the sample gradient

$$∇ {f}_{i} ( {z}_{i}^{t} , {b}_{i}^{t} )$$

of the defined node i in the t-th iteration, the clipping threshold thereof is

$${Δ}_{i}^{⌊ t / {τ}_{1} ⌋} ,$$

and τ₁ represents the first time interval; when

$$∇ {f}_{i} ( {z}_{i}^{t} , {b}_{i}^{t} ) > {Δ}_{i}^{⌊ t / {τ}_{1} ⌋} : ∇ {f}_{i}^{′} ( {z}_{i}^{t} , {b}_{i}^{t} ) = \frac{∇ {f}_{i} ( {z}_{i}^{t} , {b}_{i}^{t} )}{‖ ∇ {f}_{i} ( {z}_{i}^{t} , {b}_{i}^{t} ) ‖} {Δ}_{i}^{⌊ t / {τ}_{1} ⌋} ; \qquad ( 1 )$$

in formula (1):

$$∇ {f}_{i}^{′} ( {z}_{i}^{t} , {b}_{i}^{t} )$$

represents the sample gradient after clipping;

$${Δ}_{i}^{⌊ t / {τ}_{1} ⌋}$$

represents the pruning threshold of the t-th iteration round; and τ₁ represents the first time interval.

Further, the clipping threshold in this embodiment is stepwise attenuated based on the set first time interval τ₁ during the iteration process, that is, given an initial clipping threshold

$${Δ}_{i}^{0} = Δ ,$$

the clipping threshold is attenuated once every first time interval τ₁, and then:

$${Δ}_{i}^{⌊ t / {τ}_{1} ⌋ + 1} = {ψΔ}_{i}^{⌊ t / {τ}_{1} ⌋} ; \qquad ( 2 )$$

in formula (2):

$${Δ}_{i}^{⌊ t / {τ}_{1} ⌋ + 1}$$

represents the clipping threshold within the next first time interval τ₁; and ψ represents the attenuation coefficient.

It should be understood that multiple rounds of iterations may occur within each first time interval τ₁.

In this step, the initial local gradient is calculated using the clipped sample gradient:

$${g}_{i}^{t} = \frac{1}{B} {\sum }_{b = 1}^{B} ∇ {f}_{i}^{′} ( {z}_{i}^{t} , {b}_{i}^{t} ) ; \qquad ( 3 )$$

in formula (3): gᵢ^{t} represents the initial local gradient of the defined node i in the t-th iteration; B represents the total number of samples in the local dataset Dᵢ of the defined node i; and b represents the b-th sample in the local dataset Dᵢ.
S2: injecting Gaussian noise into the initial local gradient of the defined node to obtain an intermediate local gradient, where the intensity of the injected Gaussian noise is adjusted by noise intensity coefficients, and the intensity of the injected Gaussian noise is stepwise attenuated based on the set time intervals during the iteration process.

In differential privacy techniques, a fixed noise positively correlated with a clipping threshold is usually added to the gradient during the iteration process. However, it can be observed that adding noise of larger intensity for smaller gradient values affects the direction of the gradient. As the number of iterations increases, the model parameters gradually approach the optimal value and the gradient value approaches zero. At this stage, if a larger intensity of noise is added to the gradient, it will affect the direction of the gradient to a certain extent, thereby increasing the negative impact of the noise error on the accuracy of the model.

In order to alleviate this problem, this embodiment proposes a learning method for attenuated noise perturbation. In the early stage of iteration, the gradient value is large, so a larger intensity of noise is added to the gradient. As the iterative model parameters gradually approach the optimal value, the gradient value will gradually approach 0. Therefore, at this stage, adding noise of smaller intensity to the gradient can reduce the negative impact on the gradient direction.

The Gaussian noise intensity is defined as

$${α}_{1 i}^{t} {σ}_{i} ( {α}_{1 i}^{t} > 1 ) ,$$

where

$${α}_{1 i}^{t} = {α}_{1 i}^{⌊ t / {τ}_{2} ⌋}$$

represents the first noise intensity coefficient of the defined node i in the t-th iteration round, and the first noise intensity coefficient

$${α}_{1 i}^{t}$$

increases stepwise based on the set second time interval τ₂ during the iteration process; σᵢ Represents the standard deviation of the Gaussian noise added of the node i. By setting the value of

$${α}_{1 i}^{t} {σ}_{i} ( {α}_{1 i}^{t} > 1 ) ,$$

a Gaussian noise intensity

$${α}_{2 i}^{t} {σ}_{i}$$

that is attenuated over time is introduced during the iteration process, where

$${α}_{2 i}^{t} = {α}_{i}^{⌊ ( T - t ) / {τ}_{2} ⌋}$$

represents the second noise intensity coefficient of the defined node i in the t-th iteration round, and the second noise intensity coefficient

$${α}_{2 i}^{t}$$

decreases stepwise based on the set second time interval τ₂ during the iteration process. Then, the attenuated Gaussian noise intensity

$${α}_{2 i}^{t} {σ}_{i}$$

can be adjusted by controlling the size of the first noise intensity coefficient

$${α}_{1 i}^{t} .$$

In one embodiment, an attenuation strategy: stepwise attenuation is provided. Stepwise attenuation is updated at intervals that vary according to the step size.

In order to ensure the security of local privacy data and avoid the risk of leakage, before the node client sends the gradient information obtained from local training to the server or adjacent nodes, Gaussian noise is injected into the gradient to achieve effective protection of the gradient data. That is, Gaussian noise is injected into the initial local gradient of the defined node, and the intermediate local gradient is obtained as:

$${\overline{g}}_{i}^{t} = {g}_{i}^{t} + {α}_{2 i}^{t} {Δ}_{i}^{⌊ t / {τ}_{1} ⌋} \cdot 𝒩 ( 0 , {σ}_{i}^{2} {I}_{d} ) ; \qquad ( 4 )$$

in formula (4):

$${\overline{g}}_{i}^{t}$$

represents the intermediate local gradient of the defined node i in the t-th iteration round;

$${α}_{2 i}^{t} = {α}_{i}^{[ ( T - t ) / {τ}_{2} ]} ,$$

represents the second noise intensity coefficient of the defined node i in the t-th iteration round, T represents the total number of iterations, τ₂ represents the second time interval, and the second noise intensity coefficient

$${α}_{2 i}^{t}$$

decreases stepwise based on the set second time interval τ₂ during the iteration process; and

$$𝒩 ( 0 , {σ}_{i}^{2} {I}_{d} )$$

represents Gaussian noise with expectation of 0 and a variance of

$${σ}_{i}^{2} {I}_{d} .$$

Based on the above formula, the intensity of the injected Gaussian noise is eventually stepwise attenuated.

At a given privacy level, adding stronger noise at the beginning of training may speed up the convergence of the model, because adding random perturbations to random gradient descent during training can make the gradient escape from saddle points quickly. As the gradient gets smaller and smaller, the noise has a greater impact on the model. Therefore, in the later stages of training, smaller noise scales are required to bring the model close to optimization.

Most literature assumes that each client has the same privacy protection requirements, but considering the differences in different countries, laws or work backgrounds, this assumption is unreasonable in practical applications. In actual situations, the privacy requirements of clients may vary. In addition, the same privacy protection level means wasting a large amount of privacy budget for some clients, which usually has a negative impact on model accuracy. Therefore, this embodiment proposes a reasonable noise distribution method without clipping, allowing each node to have a personalized privacy protection level (∈ᵢ,δᵢ)−DP, where ∈ᵢ is the privacy budget of the node i, δᵢ is the failure probability of the node i, and DP is the differential privacy.

Differential privacy is an effective technology for protecting personal privacy and has been rigorously proven in theory. However, when using differential privacy technology, it is necessary to find a way to balance the privacy protection effect and data analysis accuracy. In differential privacy, a preset privacy protection level is generally achieved by adding Gaussian noise proportional to the sensitivity of the data, but this will reduce the accuracy of the analysis.

In order to alleviate this contradiction, the method disclosed in this embodiment allows each node to have a personalized privacy protection level (∈ᵢ,δᵢ)−DP. This method can reduce the error caused by noise as much as possible, so that the training process of the model can achieve an ideal convergence effect.

Specifically, a randomized algorithm M satisfies (∈ᵢ,δᵢ)−DP, if for any adjacent datasets D and D′, and any subset S of the output set of algorithm M, then: Pr[M(D)∈S≤e^{∈}×Pr[M(D′)∈S+δ, ∈ is the privacy budget, which controls the balance between privacy and accuracy, and a smaller ∈ provides a stronger privacy guarantee; and δ is the failure probability.

That is to say, there are constants cᵢ and c₂, N is the total sample size of a given image dataset (i.e., CIFAR-10 dataset), given the total number T of iterations, for any

$${ϵ}_{i} < \frac{{c}_{1} T {B}^{2}}{{N}^{2}} , {δ}_{i} > 0 ,$$

to achieve the privacy protection level (∈ᵢ,δᵢ)−DP, the value of σᵢ must be satisfied, that is:

$${σ}_{i} = \frac{\sqrt[{c}_{2} B]{log ( \frac{1}{{δ}_{i}} )}}{N {ϵ}_{i}} \sqrt{{\sum }_{t = 0}^{T - 1} \frac{1}{{( {α}_{1 i}^{t} )}^{2}}} . \qquad ( 5 )$$

That is, the required privacy protection level (∈ᵢ,δᵢ)−DP can be achieved only when the standard deviation σᵢ of the Gaussian noise added by the defined node satisfies the above formula.
S3: using an adaptive historical gradient aggregation method to aggregate the intermediate local gradient of the defined node in the current iteration round and target local gradients in historical iteration rounds to obtain a target local gradient of the defined node in the current iteration round.

In order to further reduce the error caused by noise and speed up the convergence, in one embodiment, the historical gradient aggregation method (AA) is used to perform iterative updating, which can further reduce the noise variance through aggregation.

Usually, the way to aggregate historical gradients is to use historical gradients for aggregation to increase or decrease the noise variance. However, historical gradients are stale, that is, the farther away from the current moment, the higher the staleness of the gradient, and the closer to the current moment, the lower the staleness of the gradient. Stale gradients can harm model performance or even cause the training process to diverge. This embodiment proposes a stepwise attenuation strategy to adaptively update old gradients and reduce the impact of historical gradients on the algorithm.

Specifically, it is first determined whether the second noise intensity coefficient

$${α}_{2 i}^{t}$$

in the current iteration round is equal to the second noise intensity coefficient

$${α}_{2 i}^{t - 1}$$

in the previous iteration round. If

$${α}_{2 i}^{t} = {α}_{2 i}^{t - 1} ,$$

then:

$${\tilde{g}}_{i}^{t} = ( 1 - θ ) {\overline{g}}_{i}^{t} + θ {\tilde{g}}_{i}^{t - 1} ; \qquad ( 6 )$$

in formula (6):

$${\tilde{g}}_{i}^{t}$$

represents the target local gradient of the defined node i in the t-th iteration round; θ is a hyperparameter, with a value of [0, 1); and

$${\tilde{g}}_{i}^{t - 1}$$

represents the target local gradient of the defined node i in the t−1-th iteration.

It should be understood that if

$${α}_{2 i}^{t} \neq {α}_{2 i}^{t - 1} ,$$

then:

$${\tilde{g}}_{i}^{t} = {\overline{g}}_{i}^{t} ,$$

that is, no aggregation operation is performed on the gradients, because if the noise intensity coefficients are not equal, then the aggregation may cause the noise to become larger.

Adaptively updating old gradients to reduce the impact of noise is effective. Specifically, in the t-th iteration round, it is assumed that the second time interval τ₂ to which this iteration belongs contains the previous (t−1)mod τ₂ historical gradients. In this iteration round, the gradient calculated in the current t-th iteration round (intermediate local gradient) is aggregated with the previous (t−1)mod τ₂ historical gradients (target local gradients) in this time interval. Specifically, assuming that in the t-th iteration round, the second time interval τ₂ belonging to the t-th iteration round includes the previous (t−1)mod τ₂ historical gradients, the previous (t−1)mod τ₂ historical gradients are aggregated with the gradients of the t-th iteration round to reduce the impact of noise errors.

For the aggregated gradients in the t-th iteration round, the following analysis is performed: The AA method performs aggregation by the previous (t−1)mod τ₂ historical gradients and the gradient obtained by calculation of the t-th iteration round, which reduces the noise error. However, due to the staleness effect, every gradient updated by a node client contains stale errors. Therefore, a reasonable time interval can be set to aggregate historical gradients, and set a second time interval τ₂ to control the impact of stale gradients on convergence.

In the theoretical derivation part, a method for setting the second time interval τ₂ is given. Assuming that the error d_{τ}_{₂} between the historical gradient and the current gradient satisfies

$${max}_{γ ∈ ( t - ( t - 1 ) mod {τ}_{2} ) , t )} {‖ {g}_{i}^{t} - {g}_{i}^{γ} ‖}^{2} \leq {d}_{{τ}_{2}} ,$$

the gradient can be decomposed into three parts:

$$E \{ {\tilde{g}}_{i}^{t} \} = E \{ {g}_{i}^{t} \} + E \{ {d}_{{r}_{2}} \} + E \{ {Δ}_{i}^{⌊ t / {τ}_{2} ⌋} \} ; and \qquad ( 7 )$$

$$h = \frac{( 1 - θ )}{( 1 + θ )} ( 1 - {θ}^{2 ( {τ}_{2} - 1 )} ) + {θ}^{2 ( {τ}_{2} - 1 )} = \frac{( 1 - θ )}{( 1 + θ )} + \frac{2}{( 1 + θ )} {θ}^{2 {τ}_{2} - 1} ; \qquad ( 8 )$$

in formula (7) and formula (8):

$$E \{ {\tilde{g}}_{i}^{t} \}$$

represents the estimated value of the target local gradient after aggregation in the t-th iteration round;

$$E \{ {g}_{i}^{t} \}$$

represents the estimated value of the intermediate local gradient after clipping in the t-th iteration round; E{d_{τ}_{₂}} represents the bias due to staleness effect;

$$E \{ {Δ}_{i}^{⌊ t / {τ}_{2} ⌋} \}$$

represents the error due to noise; and h represents the magnitude of noise reduction when the adaptive historical gradient aggregation method is used.

It can be seen that there is a balance between stale bias error and noise error. When the hyperparameter θ is small, the weight of the current gradient is large, that is, the stale bias error is small. When the hyperparameter θ is larger, the noise error is smaller. When the hyperparameter θ=0, the algorithm degenerates into ordinary gradient descent, where the stale bias error is 0 and the noise error is maximum. When the hyperparameter θ is fixed, the larger the value of τ₂, the smaller the noise error, but the larger the stale bias error, and vice versa.
S4: calculating a learning rate in the current iteration round based on the noise intensity coefficients, using the target local gradient obtained through aggregation to update local model parameters of the defined node, and then passing the updated local model parameters to the adjacent nodes for model parameter updating.

An initial learning rate of η is given. The size of the learning rate coefficient η^{t} is further considered, which has an important impact on the noise error. In this embodiment, the learning rate in the current iteration round is calculated based on the noise intensity coefficient:

$$\{ \begin{matrix}{η}^{t} = η / {β}_{i}^{t} \\ {β}_{i}^{t} = \{ \begin{matrix}{α}_{1 i}^{t} {α}_{2 i}^{t} , t \leq T / 2 \\ {α}_{1 i}^{t} {α}_{1 i}^{t} , t > T / 2\end{matrix}\end{matrix} ; \qquad ( 9 )$$

in formula (9): η^{t} represents the learning rate in the t-th iteration round; η represents the initial learning rate; and

$${β}_{i}^{t}$$

represents the learning rate coefficient of the defined node i in the t-th iteration round.

It should be further explained here that by setting the learning rate η^{t} to a reasonable value and ensuring that the learning rate coefficient

$${β}_{i}^{t}$$

is greater than the first noise intensity coefficient

$${α}_{1 i}^{t} ,$$

the error value caused by the noise can be reduced, thereby optimizing the final convergence result under the same number of iterations.

Setting of the learning rate coefficient

$${β}_{i}^{t} :$$

In order to better reduce the noise error, according to the first noise intensity coefficient

$${α}_{1 i}^{t} ,$$

the learning rate coefficient is set to

$${β}_{i}^{t} = \{ \begin{matrix}{α}_{1 i}^{t} {α}_{2 i}^{t} , t \leq T / 2 \\ {α}_{1 i}^{t} {α}_{1 i}^{t} , t > T / 2\end{matrix} ,$$

of which the theoretical analysis is as follows:

For

$${β}_{i}^{t} = \{ \begin{matrix}{α}_{1 i}^{t} {α}_{2 i}^{t} , t \leq T / 2 \\ {α}_{1 i}^{t} {α}_{1 i}^{t} , t > T / 2\end{matrix} ,$$

in the proof process, the variance of the noise is

$$\frac{d}{n} {\sum }_{1 = 1}^{η} {σ}_{i}^{2} {\sum }_{t = 0}^{T} \frac{{( {a}_{2 i}^{t} )}^{2}}{{( {β}^{t} )}^{2}} ,$$

where d represents the dimension of the model parameters and n represents the number of nodes; it can be seen that:

When

$${β}_{i}^{t} = {α}_{1 i}^{t} {α}_{2 i}^{t} or {β}_{i}^{t} = {α}_{1 i}^{t} {α}_{1 i}^{t} ,$$

the variance of the noise is

$$\frac{d}{n} {\sum }_{1 = 1}^{η} {σ}_{i}^{2} {\sum }_{t = 0}^{T} \frac{1}{{( {α}_{1 i}^{t} )}^{2}} .$$

When

$${β}_{i}^{t} = \{ \begin{matrix}{α}_{1 i}^{t} {α}_{2 i}^{t} , t \leq T / 2 \\ {α}_{1 i}^{t} {α}_{1 i}^{t} , t > T / 2\end{matrix} ,$$

the variance of the noise is

$$\frac{d}{n} {\sum }_{1 = 1}^{η} {σ}_{i}^{2} {\sum }_{t = 0}^{T / 2} \frac{1}{{( {α}_{1 i}^{t} )}^{2}} + \frac{d}{n} {\sum }_{1 = 1}^{η} {σ}_{i}^{2} {\sum }_{t = T / 2}^{T} \frac{{( {α}_{2 i}^{t} )}^{2}}{{( {α}_{1 i}^{t} )}^{4}} .$$

Since the first noise intensity coefficient

$${α}_{1 i}^{t}$$

is a stepwise increasing function:

$$\frac{d}{n} {\sum }_{1 = 1}^{η} {σ}_{i}^{2} {\sum }_{t = T / 2}^{T} \frac{{( {α}_{2 i}^{t} )}^{2}}{{( {α}_{1 i}^{t} )}^{4}} \leq \frac{d}{n} {\sum }_{1 = 1}^{η} {σ}_{i}^{2} {\sum }_{t = T / 2}^{T} \frac{1}{{( {α}_{1 i}^{t} )}^{2}} ; and$$

$$\frac{d}{n} {\sum }_{1 = 1}^{η} {σ}_{i}^{2} {\sum }_{t = 0}^{T / 2} \frac{1}{{( {α}_{1 i}^{t} )}^{2}} + \frac{d}{n} {\sum }_{1 = 1}^{η} {σ}_{i}^{2} {\sum }_{t = T / 2}^{T} \frac{{( {α}_{2 i}^{t} )}^{2}}{{( {α}_{1 i}^{t} )}^{4}} \leq \frac{d}{n} {\sum }_{1 = 1}^{η} {σ}_{i}^{2} {\sum }_{t = 0}^{T} \frac{1}{{( {α}_{1 i}^{t} )}^{2}} .$$

From the above theoretical analysis, it can be seen that this setting can effectively reduce the noise error.

Then, based on random gradient descent, the local model parameters of the defined node are updated using the aggregated target local gradient, that is:

$${x}_{i}^{t + 1 / 2} = {x}_{i}^{t} - {η}^{t} {\tilde{g}}_{i}^{t} ; \qquad ( 10 )$$

in formula (10):

$${x}_{i}^{t + 1 / 2}$$

represents the intermediate model parameters of the defined node i obtained through updating, which is used for exchange between nodes before each round of parameter aggregation and for subsequent model parameter updates; and

$${x}_{i}^{t}$$

Represents the local model parameters of the defined node before updating.
S5: receiving, by the defined node, updated model parameters of the adjacent nodes thereof and performing aggregation to obtain the local model parameters of the next iteration round.

It is known that during the learning process, each node needs to maintain three variables: model parameter x, scalar push weight w, and debiasing parameter z.

Initial parameters are given, which includes: initial scalar push weight

$${w}_{i}^{0} = 1 ,$$

initial model parameter

$${x}_{i}^{0} = 1 ,$$

initial debiasing parameter

$${z}_{i}^{0} = 1.$$

The update rules for the three variables maintained by the node during the learning process are as follows:
\textcircled{1} The node pushes and receives parameters, including: the defined node i pushes parameters

$$( {x}_{i}^{t + 1 / 2} , {w}_{i}^{t} )$$

to adjacent nodes j thereof, and the defined node i receives parameters

$$( {x}_{j}^{t + 1 / 2} , {w}_{j}^{t} )$$

sent by adjacent nodes thereof j.
\textcircled{2} The node updates parameters, that is, the defined node receives the updated model parameters of adjacent nodes thereof and performs aggregation to obtain the local model parameters of the next iteration round, specifically:

$$\{ \begin{matrix}{x}_{i}^{t + 1} = {\sum }_{j = 1}^{n} {P}_{i , j}^{t} {x}_{j}^{t + 1 / 2} \\ {w}_{i}^{t + 1} = {\sum }_{j = 1}^{n} {P}_{i , j}^{t} {w}_{j}^{t} \\ {z}_{i}^{t + 1} = {x}_{i}^{t + 1} / {w}_{i}^{t + 1}\end{matrix} ; \qquad ( 11 )$$

in formula (11):

$${x}_{i}^{t + 1}$$

represents the local model parameters of the defined node i in the t+1-th iteration round; n represents the number of nodes;

$${P}_{i , j}^{t}$$

represents the weight from the adjacent node j to the defined node i in the t-th iteration round;

$${x}_{j}^{t + 1 / 2}$$

represents the updated intermediate model parameters of the adjacent node j;

$${w}_{i}^{t + 1}$$

represents the scalar push weight of the defined node i in the t+1-th iteration round;

$${w}_{j}^{t}$$

represents the scalar push weight of the adjacent node j, obtained through updating; and

$${z}_{i}^{t + 1}$$

represents the debiasing parameter of the defined node i in the t+1-th iteration round.

It should be understood that the Push-Sum technique is applied here, and the push weight w can be used to control the size of the model parameter x. Since

$${\sum }_{j = 1}^{n} {P}_{i , j}^{t}$$

is not necessarily 1, it may be very large, making

$${x}_{i}^{t + 1}$$

also very large, so the debiasing parameter

$${z}_{i}^{t + 1}$$

is introduced for control.

Through the above steps, it is assumed that the loss function

$$∇ {f}_{i} ( {x}_{i}^{t} , {b}_{i}^{t} )$$

of the local sample satisfies the following conditions: Lipschitz continuity ∥∇ƒ(x)−∇ƒ(y)∥≤L∥x−y∥ and boundedness

$$‖ ∇ {f}_{i} ( x ) - ∇ f ( x ) ‖ \leq {a}^{2} , \frac{1}{n} {\sum }_{i = 1}^{n} ‖ ∇ {f}_{i} ( {x}_{i}^{t} , {b}_{i}^{t} ) - ∇ f ( {x}_{i}^{t} ) ‖ \leq {m}^{2} .$$

The first noise intensity coefficient

$${α}_{1 i}^{t}$$

is made to be proportional to the total number T of iterations, where

$${α}_{1 i}^{t} ∝ {T}^{\frac{1}{4} - \frac{p}{2}} ,$$

is the set value and

$$p ∈ [ - \frac{3}{2} , \frac{1}{2} ] .$$

The learning rate coefficient is

$${β}_{i}^{t} = \{ \begin{matrix}{α}_{1 i}^{t} {α}_{2 i}^{t} , t \leq T / 2 \\ {α}_{1 i}^{t} {α}_{1 i}^{t} , t > T / 2\end{matrix} ,$$

η is the initial learning rate, set to

$$η = O ( \frac{\sqrt{n}}{{T}^{P}} ) ,$$

and O(•) represents omitting the constant factor.

When

$$\frac{η}{{β}^{t}} \leq \frac{1}{L} ,$$

L is the Lipschitz constant:

$$\{ \begin{matrix}\frac{1}{n T} {\sum }_{t = 0}^{T - 1} {\sum }_{i = 1}^{n} E \{ {‖ ∇ {f}_{i} ( {z}_{i}^{t} ) ‖}^{2} \} \leq \\ \frac{16 {KF}_{0} + 8 {Km}^{2} + 8 K {‖ {x}_{i}^{( 0 )} ‖}^{2} + 24 {Ka}^{2} + 6 KLhU + 8 {TKhd}_{{τ}_{2}}}{\sqrt{nT}} \\ U = \frac{2 Δ d {c}_{2}^{2} {η}^{2}}{{n}^{2} {B}^{2}} {\sum }_{i = 1}^{n} \frac{ln ( 1 / {δ}_{i} )}{{ϵ}_{i}^{2}} {\sum }_{t = 0}^{T - 1} \frac{{( {a}_{2 i}^{t} )}^{2}}{{( {β}^{t} )}^{2}} {\sum }_{t = 0}^{T - 1} \frac{1}{{( {a}_{1 i}^{r} )}^{2}} \\ {β}^{t} \leq {KT}^{\frac{1}{2} - p} \\ {F}_{0} = F ( {x}_{0} ) - {f}^{*} , {f}^{*} = min ( F ( x ) )\end{matrix} ; \qquad ( 12 )$$

in formula (12):

$$∇ {f}_{i} ( {z}_{i}^{t} )$$

represents the gradient of the loss function ƒᵢ on the local dataset with respect to the debiasing parameter; K is a constant; F₀ represents the gap between the initial function value F(x₀) and the optimal solution ƒ*; m represents the upper limit of the unbiased error of the local gradient;

$${x}_{i}^{( 0 )}$$

represents the initialized model parameters; a represents the boundary between local and global gradients; L represents the Lipschitz constant, which is used to characterize the limit of gradient change, that is, the maximum rate of change at which the gradient will not change too quickly; U is the noise error.

For the last two items of the convergence results

$$( i . e . \frac{6 KLhM + 8 TKh {d}_{{τ}_{2}}}{\sqrt{nT}} ) ;$$

it can be seen that they are in a balanced relationship. When the second time interval τ₂ is larger, the amplitude h will be smaller, the error d_{τ}_{_{z}} will increase, but the amplitude h will be limited by

$$\frac{( 1 - θ )}{( 1 + θ )} ,$$

so the size of the second time interval τ₂ should be set reasonably.

A value of θ is given, assuming there is a reasonable value of the second time interval τ₂, then the amplitude h is fixed. The current goal is to minimize the impact of the error d_{τ}_{₂} as much as possible, but it is difficult to directly analyze the error d_{τ}_{₂} and its size is also difficult to define.

Assuming that the error d_{τ}_{₂} between the historical gradient and the current gradient satisfies

$${max}_{γ ∈ ( t - ( t - 1 ) mod {τ}_{2} ) , t )} {‖ {g}_{i}^{t} - {g}_{i}^{γ} ‖}^{2} \leq {d}_{{τ}_{2}} ,$$

that is, the error d_{τ}_{₂} is controlled by

$${max}_{γ ∈ ( t - ( t - 1 ) {mod τ}_{2} ) , t )} {‖ {g}_{i}^{t} - {g}_{i}^{γ} ‖}^{2} \leq {d}_{{τ}_{2}} ,$$

combined with formulas (1) and (3), it can be seen that the size of the clipping threshold can be reasonably controlled to control the size of

$${g}_{i}^{t} and {g}_{i}^{γ} ,$$

thereby controlling the size of

$${‖ {g}_{i}^{t} - {g}_{i}^{γ} ‖}^{2} ,$$

and then controlling the size of the error d_{τ}_{₂}. For example, when

$${g}_{i}^{t} and {g}_{i}^{γ}$$

are subject to the same clipping threshold (or clipping), then it will be limited to the clipping threshold (or 0), greatly reducing the error caused by the error d_{τ}_{₂}. In this way, the unquantifiable error d_{τ}_{₂} can be converted into a quantifiable clipping threshold.

The effectiveness of this method is verified by combining specific experiments below.

This method trains a convolutional neural network (CNN) model for image classification on the Cifar-10 dataset.

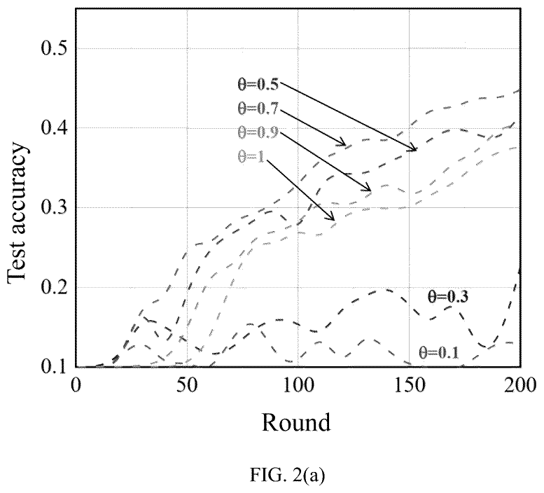

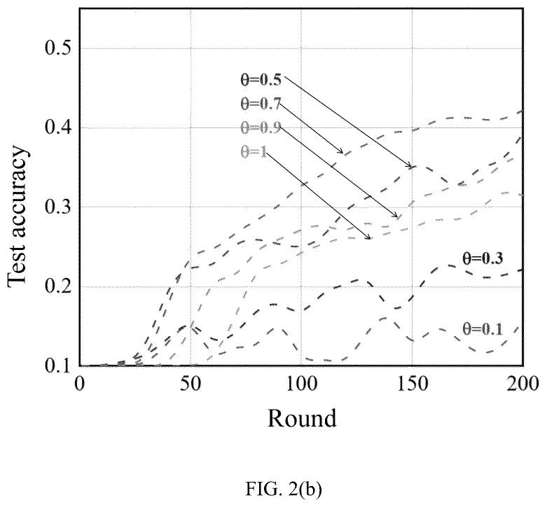

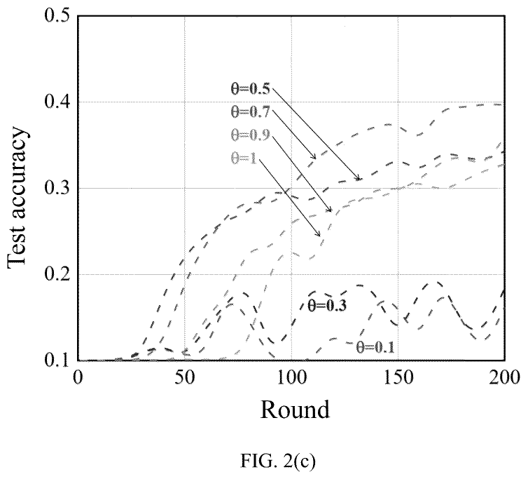

First, an ablation experiment is conducted to test the relationship between the value of the hyperparameter θ and the convergence effect, and 200 rounds of testing were performed under the conditions of σᵢ=5, σᵢ=10 and σᵢ=15. The experimental results are shown in FIG. 2 (a), FIG. 2 (b), and FIG. 2 (c), respectively. FIG. 2 (a) is a diagram showing the relationship between a value of parameter θ and a convergence effect when σ₁=5; FIG. 2 (b) is a diagram showing the relationship between a value of parameter θ and a convergence effect when σ₁=10; FIG. 2 (c) is a diagram showing the relationship between a value of parameter θ and a convergence effect when σᵢ=15.

It can be seen from the above figures that the effect is better when the parameters are θ=0.7, θ=0.5, and θ=0.3.

Further, the influence of gradient staleness is analyzed, and based on this, a strategy for setting the second time interval τ₂ is given. For

$$h = \frac{( 1 - θ )}{( 1 + θ )} + \frac{2}{( 1 + θ )} {θ}^{2 {τ}_{2} - 1} ,$$

it can be seen that when the second time interval τ₂ is larger, the amplitude h will be smaller, and then the error will be smaller. However, the amplitude h will be limited by the constant term

$$\frac{( 1 - θ )}{( 1 + θ )} ,$$

so under the limitation of the constant term, it is unreasonable to blindly increase the second time interval τ₂. Therefore, this method gives a strategy for setting the second time interval τ₂, that is, when the value of the parameter θ is given, with

$$\frac{( 1 - θ )}{( 1 + θ )}$$

as the boundary, when the value of the second time interval τ₂ satisfies that

$$h - \frac{( 1 - θ )}{( 1 + θ )}$$

is less than 0.01, the value of the second time interval τ₂ is taken as the time interval.

Assuming θ=0.5, the size of

$$\frac{( 1 - θ )}{( 1 + θ )} and \frac{2}{( 1 + θ )} {θ}^{2 {τ}_{2} - 1}$$

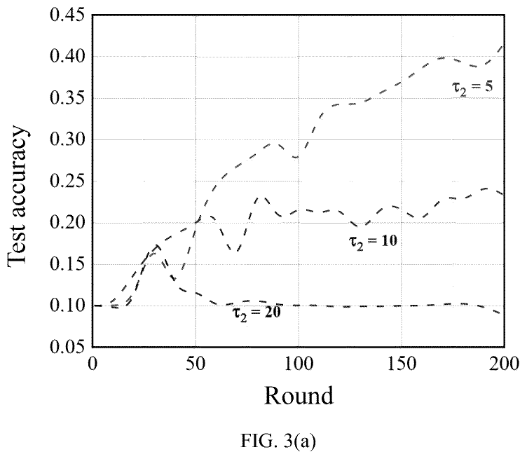

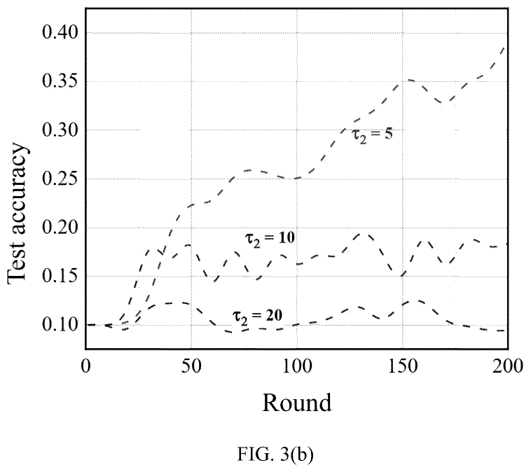

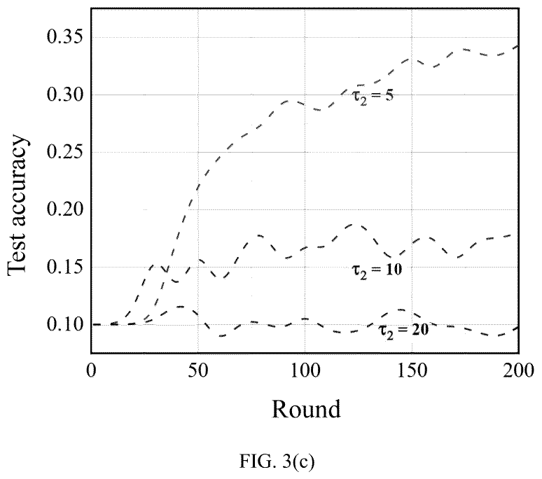

can be further calculated. Hence, when the second time interval τ₂≥5, h basically remains unchanged. At this time, if the second time interval τ₂ increases, the impact of gradient staleness will be aggravated. Therefore, this method conducts experiments based on the second time interval τ₂ in the cases of σᵢ=5, σᵢ=10, σᵢ=15 and verifies the theoretical analysis. The experimental results are shown in FIG. 3 (a), FIG. 3 (b), and FIG. 3 (c), respectively. FIG. 3 (a) is a diagram showing the relationship between a value of the second time interval τ₂ and a convergence effect when σᵢ=5; FIG. 3 (b) is a diagram showing the relationship between a value of the second time interval τ₂ and a convergence effect when σᵢ=10; FIG. 3 (c) is a diagram showing the relationship between a value of the second time interval τ₂ and a convergence effect when σᵢ=15.

Finally, the DP-ASGP method is compared with the MAPA (multi-stage asynchronous federated learning with adaptive differential privacy) method and the A(DP)2SGD (asynchronous decentralized parallel random gradient descent algorithm with differential privacy) method.

It is set

$$n = 10 , p = 0.2 , δ = 1 {0}^{- 5} , η = \frac{0.1 \sqrt{n}}{{T}^{P}} , θ = 0.5 , {σ}_{i} = 10 , ψ = 0.9 , {τ}_{2} = 5 ,$$

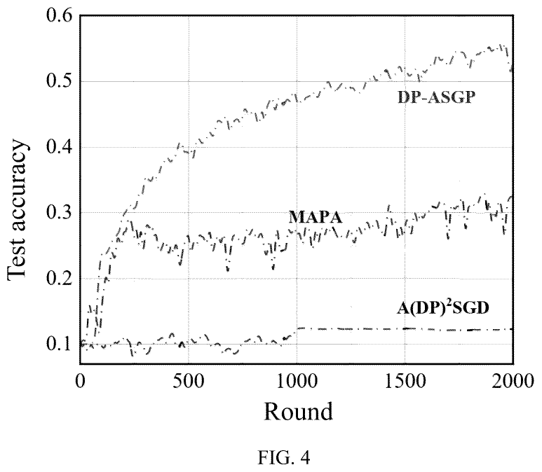

and clipping threshold attenuation is performed every 100 rounds. α₁ᵢ^{t}=((t+10)^{0.2}) is set, where the first iteration of each time interval is the noise system of that time interval. The test accuracy is used to evaluate the performance of distributed learning. The comparative experimental results are shown in FIG. 4. Experimental results show that under the same number of iterations, the proposed method DP-ASGP shows good convergence effect.

### Embodiment 2

In one embodiment, a device for implementing an adaptive privacy-protection distributed learning method based on attenuated noise perturbation is provided, which includes:
a gradient acquisition module configured to acquire a sample gradient of the defined node in a current iteration round based on the local dataset, use a clipping threshold of the current iteration round to clip the sample gradient, and use the clipped sample gradient to calculate an initial local gradient, where the clipping threshold is stepwise attenuated based on set time intervals during an iteration process;
a gradient noise adding module configured to inject Gaussian noise into the initial local gradient of the defined node to obtain an intermediate local gradient, where the intensity of the injected Gaussian noise is adjusted by noise intensity coefficients, and the intensity of the injected Gaussian noise is stepwise attenuated based on the set time intervals during the iteration process;
a gradient aggregation module configured to use an adaptive historical gradient aggregation method to aggregate the intermediate local gradient of the defined node in the current iteration round and target local gradients in historical iteration rounds to obtain a target local gradient of the defined node in the current iteration round;
a parameter update module configured to calculate a learning rate in the current iteration round based on the noise intensity coefficients, use the target local gradient obtained through aggregation to update local model parameters of the defined node, and then pass the updated local model parameters to the adjacent nodes for model parameter updating; and
a parameter aggregation module configured to aggregate updated model parameters of the adjacent nodes to obtain the local model parameters of the next iteration round.

### Embodiment 3

In one embodiment, electronic equipment is further provided, which includes:
at least one processor; and a memory storing instructions, where when executed by the at least one processor, the instructions enable the at least one processor to perform the adaptive privacy-protection distributed learning method based on attenuated noise perturbation as described above.

In this embodiment, the electronic equipment may include but is not limited to: personal computers, server computers, workstations, desktop computers, laptop computers, notebook computers, mobile computing equipment, smart phones, tablet computers, cellular phones, personal digital assistants (PDAs), handheld devices, messaging equipment, wearable computing equipment, consumer electronic equipment, etc.

### Embodiment 4

In one embodiment, a machine-readable storage medium is further provided, the machine-readable storage medium storing executable instructions, where when executed, the instructions enable a machine to perform the adaptive privacy-protection distributed learning method based on attenuated noise perturbation as described above.

Specifically, a system or device equipped with the readable storage medium may be provided, software program codes that implement the functions of any of the above-mentioned embodiments are stored in the system or device, and a computer or processor of the system or device can read and execute instructions stored in the readable storage medium.

In this case, the program code itself read from the machine-readable medium can realize the function of any one of the above embodiments, and thus the machine-readable code and the machine-readable storage medium storing the machine-readable code constitute part of this specification.

Embodiments of the readable storage medium include floppy disks, hard disks, magneto-optical disks, optical disks (e.g., CD ROM, CD R, CD RW, DVD ROM, DVD RAM, DVD RW, DVD RW), magnetic tapes, nonvolatile memory cards, and ROMs. Alternatively, the program code may be downloaded from a server computer or a cloud via a communications network.

Those skilled in the art should understand that the embodiments of this disclosure may be provided as a method, a system, or a computer program product. Accordingly, this disclosure may take the form of an entirely hardware embodiment, an entirely software embodiment, or an embodiment combining software and hardware aspects. Further, this disclosure may take the form of a computer program product implemented on one or more computer-usable storage media (including but not limited to disk storage, CD ROM, optical storage, etc.) containing computer-usable program codes.

This disclosure is described with reference to flowcharts and/or block diagrams of methods, equipment (systems), and computer program products according to embodiments of this disclosure. It should be understood that each process and/or block in the flowchart and/or block diagram, and a combination of the processes and/or blocks in the flowchart and/or block diagram can be implemented by computer program instructions. These computer program instructions can be provided to a processor of a general-purpose computer, a special-purpose computer, an embedded processor or other programmable data processing device to produce a machine, so that the instructions executed by the processor of the computer or other programmable data processing device produce a device for implementing the functions specified in one or more processes in the flowchart and/or one or more blocks in the block diagram.

These computer program instructions may also be stored in a computer-readable memory that can direct a computer or other programmable data processing device to work in a specific manner, so that the instructions stored in the computer-readable memory produce a manufactured product including an instruction device that implements the functions specified in one or more processes in the flowchart and/or one or more boxes in the block diagram.

These computer program instructions may also be loaded onto a computer or other programmable data processing device so that a series of operational steps are executed on the computer or other programmable device to produce a computer-implemented process, whereby the instructions executed on the computer or other programmable device provide steps for implementing the functions specified in one or more processes in the flowchart and/or one or more boxes in the block diagram.

Obviously, the above embodiments of this disclosure are merely examples for clearly illustrating the technical solutions of this disclosure, and are not intended to limit the specific implementation methods of this disclosure. Any modifications, equivalent substitutions and improvements made within the spirit and principles of the claims of this disclosure shall be included in the protection scope of the claims of this disclosure.

What is claimed is:

1. An adaptive privacy-protection distributed learning method based on attenuated noise perturbation, applied to a distributed-type distributed learning system, the distributed learning system comprising a defined node and adjacent nodes thereof, and each node having a local dataset used for image classification and recognition tasks; wherein the method comprises:
S1: acquiring a sample gradient of the defined node in a current iteration round based on the local dataset, using a clipping threshold of the current iteration round to clip the sample gradient, and using the clipped sample gradient to calculate an initial local gradient, wherein the clipping threshold is stepwise attenuated based on set time intervals during an iteration process;
S2: injecting Gaussian noise into the initial local gradient of the defined node to obtain an intermediate local gradient, wherein the intensity of the injected Gaussian noise is adjusted by noise intensity coefficients, and the intensity of the injected Gaussian noise is stepwise attenuated based on the set time intervals during the iteration process;
S3: using an adaptive historical gradient aggregation method to aggregate the intermediate local gradient of the defined node in the current iteration round and target local gradients in historical iteration rounds to obtain a target local gradient of the defined node in the current iteration round;
S4: calculating a learning rate in the current iteration round based on the noise intensity coefficients, using the target local gradient obtained through aggregation to update local model parameters of the defined node, and then passing the updated local model parameters to the adjacent nodes for model parameter updating; and
S5: receiving, by the defined node, updated model parameters of the adjacent nodes thereof and performing aggregation to obtain the local model parameters of the next iteration round;
wherein in S1, the sample gradient of the defined node i in the t-th iteration round is
$$∇ {f}_{i} ( {z}_{i}^{t} {b}_{i}^{t} ) ,$$
wherein
$${z}_{i}^{t}$$
represents a debiasing parameter of the defined node i in the t-th iteration round, and
$${b}_{i}^{t}$$
represents a sample sampled from the local dataset Dᵢ of the defined node i in the t-th iteration round;
wherein using a clipping threshold of the current iteration round to clip the sample gradient specifically comprises: when
$$∇ {f}_{i} ( {z}_{i}^{t} , {b}_{i}^{t} ) > {Δ}_{i}^{⌊ t / {τ}_{1} ⌋} : \qquad ( 1 )$$
$$∇ {f}_{i}^{′} ( {z}_{i}^{t} , {b}_{i}^{t} ) = \frac{∇ {f}_{i} ( {z}_{i}^{t} , {b}_{i}^{t} )}{‖ ∇ {f}_{i} ( {z}_{i}^{t} , {b}_{i}^{t} ) ‖} {Δ}_{i}^{⌊ t / {τ}_{1} ⌋} ;$$
wherein in formula (1):
$$∇ {f}_{i}^{′} ( {z}_{i}^{t} , {b}_{i}^{t} )$$
represents the sample gradient after clipping;
$${Δ}_{i}^{⌊ t / {τ}_{1} ⌋}$$
represents the clipping threshold of the t-th iteration round; and τ₁ represents a first time interval;
wherein the clipping threshold is stepwise attenuated based on the set first time interval τ₁ during the iteration process, that is:
$${Δ}_{i}^{⌊ t / {τ}_{1} ⌋ + 1} = {ψΔ}_{i}^{⌊ t / {τ}_{1} ⌋} ; \qquad ( 2 )$$
wherein in formula (2):
$${Δ}_{i}^{⌊ t / {τ}_{1} ⌋ + 1}$$
represents the clipping threshold within the next first time interval τ₁; and ψ represents an attenuation coefficient;
wherein in the S1, using the clipped sample gradient to calculate an initial local gradient is represented by:
$${g}_{i}^{t} = \frac{1}{B} {\sum }_{b = 1}^{B} ∇ {f}_{i}^{′} ( {z}_{i}^{t} , {b}_{i}^{t} ) ; \qquad ( 3 )$$
wherein in formula (3):
$${g}_{i}^{t}$$
represents the initial local gradient of the defined node i in the t-th iteration round; B represents the total number of samples in the local dataset Dᵢ of the defined node i; and b represents the b-th sample in the local dataset Dᵢ;
wherein in the S2, injecting Gaussian noise into the initial local gradient of the defined node to obtain an intermediate local gradient is represented by:
$${\overline{g}}_{i}^{t} = {g}_{i}^{t} + {α}_{2 i}^{t} {Δ}_{i}^{⌊ t / {τ}_{1} ⌋} \cdot 𝒩 ( 0 , {σ}_{i}^{2} {I}_{d} ) ; \qquad ( 4 )$$
wherein in formula (4):
$${\overline{g}}_{i}^{t}$$
represents the intermediate local gradient of the defined node i in the t-th iteration round;
$${α}_{2 i}^{t} = {α}_{i}^{⌊ ( T - t ) / {τ}_{2} ⌋} ,$$
represents a second noise intensity coefficient of the defined node i in the t-th iteration round, T represents the total number of iterations, τ₂ represents a second time interval, and the second noise intensity
$${α}_{2 i}^{t}$$
coefficient decreases stepwise based on the set second time interval τ₂ during the iteration process; and
$$𝒩 ( 0 , {σ}_{i}^{2} {I}_{d} )$$
represents Gaussian noise with an expected value of 0 and a variance of
$${σ}_{i}^{2} {I}_{d} ;$$
wherein the S3 specifically comprises:
determining whether the second noise intensity coefficient
$${σ}_{2 i}^{t}$$
in the current iteration round is equal to the second noise intensity coefficient
$${σ}_{2 i}^{t - 1}$$
in the previous iteration round; if
$${σ}_{2 i}^{t} = {σ}_{2 i}^{t - 1} ,$$
then:
$${\tilde{g}}_{i}^{t} - = ( 1 - θ ) {\overline{g}}_{i}^{t} + θ {\tilde{g}}_{i}^{t - 1} ; \qquad ( 6 )$$
and
wherein in formula (6):
$${\tilde{g}}_{i}^{t}$$
represents the target local gradient of the defined node i in the t-th iteration round; θ is a hyperparameter, with a value of [0, 1); and
$${\tilde{g}}_{i}^{t - 1}$$
represents the target local gradient of the defined node i in the t−1-th iteration round.

2. The adaptive privacy-protection distributed learning method based on attenuated noise perturbation according to claim 1, wherein in the S4, calculating a learning rate in the current iteration round based on the noise intensity coefficients is represented by:
$$\{ \begin{matrix}{η}^{t} = η / {β}_{i}^{t} \\ {β}_{i}^{t} = \{ \begin{matrix}{α}_{1 i}^{t} {α}_{2 i}^{t} , t \leq T / 2 \\ {α}_{1 i}^{t} {α}_{1 i}^{t} , t > T / 2\end{matrix}\end{matrix} ; \qquad ( 9 )$$
wherein in formula (9): η^{t} represents the learning rate in the t-th iteration round; η represents an initial learning rate;
$${β}_{i}^{t}$$
represents a learning rate coefficient of the defined node i in the t-th iteration round;
$${α}_{1 i}^{t} = {α}_{i}^{⌊ t / {τ}_{2} ⌋} ,$$
represents the first noise intensity coefficient of the defined node i in the t-th iteration round, and the first noise intensity coefficient
$${α}_{1 i}^{t}$$
increases stepwise based on the set second time interval τ₂ during the iteration process;
wherein using the target local gradient obtained through aggregation to update local model parameters of the defined node is represented by:
$${x}_{i}^{t + 1 / 2} = {x}_{i}^{t} - {η}^{t} {\tilde{g}}_{i}^{t} ; \qquad ( 10 )$$
and
wherein in formula (10):
$${x}_{i}^{t + 1 / 2}$$
represents the intermediate model parameters of the defined node i, obtained through updating; and
$${x}_{i}^{t}$$
represents the local model parameters of the defined node i before updating.

3. The adaptive privacy-protection distributed learning method based on attenuated noise perturbation according to claim 1, wherein, in the S5, receiving, by the defined node, updated model parameters of the adjacent nodes thereof and performing aggregation to obtain the local model parameters of the next iteration round specifically comprises:
$$\{ \begin{matrix}{x}_{i}^{t + 1} = {\sum }_{j = 1}^{n} {P}_{i , j}^{t} {x}_{j}^{t + 1 / 2} \\ {w}_{i}^{t + 1} = {\sum }_{j = 1}^{n} {P}_{i , j}^{t} {w}_{j}^{t} \\ {z}_{i}^{t + 1} = {x}_{i}^{t + 1} / {w}_{i}^{t + 1}\end{matrix} ; \qquad ( 11 )$$
and
wherein in formula (11):
$${x}_{i}^{t + 1}$$
represents the local model parameters of the defined node i in the t+1-th iteration round; n represents the number of nodes;
$${P}_{i , j}^{t}$$
represents a weight from the adjacent node j to the defined node i in the t-th iteration round;
$${x}_{j}^{t + 1 / 2}$$
represents the intermediate model parameters of the adjacent nodes j, obtained through updating;
$${w}_{i}^{t + 1}$$
represents a scalar push weight of the defined node i in the t+1-th iteration round;
$${w}_{j}^{t}$$
represents the scalar push weight of the adjacent node j, obtained through updating; and
$${z}_{i}^{t + 1}$$
represents the debiasing parameter of the defined node i in the t+1-th iteration round.

4. A device for implementing an adaptive privacy-protection distributed learning method based on attenuated noise perturbation, wherein the device comprises:
a gradient acquisition module configured to acquire a sample gradient of the defined node in a current iteration round based on the local dataset, use a clipping threshold of the current iteration round to clip the sample gradient, and use the clipped sample gradient to calculate an initial local gradient, wherein the clipping threshold is stepwise attenuated based on set time intervals during an iteration process;
a gradient noise adding module configured to inject Gaussian noise into the initial local gradient of the defined node to obtain an intermediate local gradient, wherein the intensity of the injected Gaussian noise is adjusted by noise intensity coefficients, and the intensity of the injected Gaussian noise is stepwise attenuated based on the set time intervals during the iteration process;
a gradient aggregation module configured to use an adaptive historical gradient aggregation method to aggregate the intermediate local gradient of the defined node in the current iteration round and target local gradients in historical iteration rounds to obtain a target local gradient of the defined node in the current iteration round;
a parameter update module configured to calculate a learning rate in the current iteration round based on the noise intensity coefficients, use the target local gradient obtained through aggregation to update local model parameters of the defined node, and then pass the updated local model parameters to the adjacent nodes for model parameter updating; and
a parameter aggregation module configured to aggregate updated model parameters of the adjacent nodes to obtain the local model parameters of the next iteration round;
wherein in the S1, the sample gradient of the defined node i in the t-th iteration round is
$$∇ {f}_{i} ( {z}_{i}^{t} , {b}_{i}^{t} ) ,$$
wherein
$${z}_{i}^{t}$$
represents a debiasing parameter of the defined node i in the t-th iteration round, and
$${b}_{i}^{t}$$
represents a sample sampled from the local dataset Dᵢ of the defined node i in the t-th iteration round;
wherein using a clipping threshold of the current iteration round to clip the sample gradient specifically comprises: when
$$∇ {f}_{i} ( {z}_{i}^{t} , {b}_{i}^{t} ) > {Δ}_{i}^{⌊ t / {τ}_{1} ⌋} : ∇ {f}_{i}^{′} ( {z}_{i}^{t} , {b}_{i}^{t} ) = \frac{∇ {f}_{i} ( {z}_{i}^{t} , {b}_{i}^{t} )}{‖ ∇ {f}_{i} ( {z}_{i}^{t} , {b}_{i}^{t} ) ‖} {Δ}_{i}^{⌊ t / {τ}_{1} ⌋} ; \qquad ( 1 )$$
wherein in formula (1):
$$∇ {f}_{i}^{′} ( {z}_{i}^{t} , {b}_{i}^{t} )$$
represents the sample gradient after clipping;
$${Δ}_{i}^{⌊ t / {τ}_{1} ⌋}$$
represents the clipping threshold of the t-th iteration round; τ₁ represents a first time interval;
wherein the clipping threshold is stepwise attenuated based on the set first time interval τ₁ during the iteration process, that is:
$${Δ}_{i}^{⌊ t / {τ}_{1} ⌋ + 1} = {ψΔ}_{i}^{⌊ t / {τ}_{1} ⌋} ; \qquad ( 2 )$$
wherein in formula (2):
$${Δ}_{i}^{⌊ t / {τ}_{1} ⌋ + 1}$$
represents the clipping threshold within the next first time interval τ₁; ψ represents an attenuation coefficient;
wherein in the S1, using the clipped sample gradient to calculate an initial local gradient is represented by:
$${g}_{i}^{t} = \frac{1}{B} {\sum }_{b = 1}^{B} ∇ {f}_{i}^{′} ( {z}_{i}^{t} , {b}_{i}^{t} ) ; \qquad ( 3 )$$
wherein in formula (3):
$${g}_{i}^{t}$$
represents the initial local gradient of the defined node i in the t-th iteration round; B represents the total number of samples in the local dataset Dᵢ of the defined node i; and b represents the b-th sample in the local dataset Dᵢ;
wherein in the S2, injecting Gaussian noise into the initial local gradient of the defined node to obtain an intermediate local gradient is represented by:
$${\overline{g}}_{i}^{t} = {g}_{i}^{t} + {α}_{2 i}^{t} {Δ}_{i}^{⌊ t / {τ}_{1} ⌋} \cdot 𝒩 ( 0 , {σ}_{i}^{2} {I}_{d} ) ; \qquad ( 4 )$$
wherein in formula (4):
$${\overline{g}}_{i}^{t}$$
represents the intermediate local gradient of the defined node i in the t-th iteration round;
$${α}_{2 i}^{t} = {α}_{i}^{⌊ ( T - t ) / {τ}_{2} ⌋} ,$$
represents a second noise intensity coefficient of the defined node i in the t-th iteration round, T represents the total number of iterations, τ₂ represents a second time interval, and the second noise intensity
$${α}_{2 i}^{t}$$
coefficient decreases stepwise based on the set second time interval τ₂ during the iteration process; and
$$𝒩 ( 0 , {σ}_{i}^{2} {I}_{d} )$$
represents Gaussian noise with an expected value of 0 and a variance of
$${σ}_{i}^{2} {I}_{d} ;$$
wherein the S3 specifically comprises:
determining whether the second noise intensity coefficient
$${α}_{2 i}^{t}$$
in the current iteration round is equal to the second noise intensity coefficient
$${α}_{2 i}^{t - 1}$$
in the previous iteration round; if
$${α}_{2 i}^{t} = {α}_{2 i}^{t - 1} ,$$
then:
$${\tilde{g}}_{i}^{t} = ( 1 - θ ) {\overline{g}}_{i}^{t} + θ {\tilde{g}}_{i}^{t - 1} ; \qquad ( 6 )$$
wherein in formula (6):
$${\tilde{g}}_{i}^{t}$$
represents the target local gradient of the defined node i in the t-th iteration round; θ is a hyperparameter, with a value of [0, 1); and
$${\tilde{g}}_{i}^{t - 1}$$
represents the target local gradient of the defined node i in the t−1-th iteration round.

5. Electronic equipment, comprising:
at least one processor; and a memory, wherein the memory stores instructions, when executed by the at least one processor, the instructions enable the at least one processor to perform the adaptive privacy-protection distributed learning method based on attenuated noise perturbation according to claim 1.

6. A machine-readable storage medium, wherein the machine-readable storage medium stores executable instructions, when executed, the instructions enable a machine to perform the adaptive privacy-protection distributed learning method based on attenuated noise perturbation according to claim 1.
